(19) United States
(12) Patent Application Publication
(10) Pub. No.: US 2003/0127819 A1
(43) Pub. Date: Jul. 10, 2003

(54) Air spring vehicle suspension with roll control and negligible creep

(76) Inventor: Gregory A. Richardson, Muskegon, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/369,817

(22) Filed: Feb. 20, 2003

Related U.S. Application Data
(63) Continuation of application No. 09/683,905, filed on Feb. 28, 2002, now abandoned.
(60) Provisional application No. 60/277,036, filed on Mar. 19, 2001.
(60) Provisional application No. 60/332,999, filed on Nov. 14, 2001.

(51) Int. Cl. B60G 9/04

(52) U.S. Cl. 280/124.157

(57) ABSTRACT

A trailer suspension comprises a pair of beams mounting a pair of axles and fluidly interconnected air springs. During normal forward travel, when one axle traverses a bump, the air springs have a low spring rate. During cornering, the spring rate is much higher to provide roll resistance. Bumpers limit the roll on an outboard side of the trailer. A flexible connector between the beam and frame further limits roll on an inboard side of the trailer. The beam is pivotally mounted to a vehicle frame rail through a relatively long radius rod thereby reducing creep to a negligible amount.

### CROSS REFERENCE TO RELATED APPLICATIONS

This application claims benefit of the following provisional applications: Serial No. 60/277,036, filed Mar. 19, 2001, and Serial No. 60/332,999, filed Nov. 14, 2001.

### BACKGROUND OF INVENTION

1. Field of the Invention

This invention relates to a trailer suspension. In one aspect, the invention relates to a trailer suspension in which trailer creep during loading of the trailer is minimal. In another aspect, the invention relates to a trailer suspension in which roll during cornering of the trailer is minimized. In another aspect, the invention relates to a trailer suspension having roll resistance similar to that of a leaf spring suspension system and the cushioned ride of an air spring suspension system. In another aspect, the invention relates to a trailer suspension that is inherently ready for loading on a flat car. In another aspect, the invention relates to a trailer suspension with an air spring suspension and the roll resistance of leaf springs without roll-induced torque of the axle. In another aspect, the invention relates to a trailer suspension in which trailer squat during loading of the trailer is limited. In another aspect, the invention relates to a trailer suspension in which dual axles are tied together through a suspension beam so that load and deflection reactions are shared by both axles essentially equally.

2. Description of the Related Art

Semi-tractor trailers frequently have suspensions with air springs to control the relative position of the trailer with respect to an axle and also to cushion the relative movement of the axle toward the trailer frame due to bumps in the road, particularly when the trailer is unloaded or lightly loaded. Air pressure in the springs is typically controlled to maintain the trailer height at a predetermined height regardless of loading.

Air springs provide superior cushioning of the trailer over a wide variation in trailer loads. However, conventional air springs by themselves generally do not develop acceptable resistance to trailer roll such as experienced when the trailer negotiates a turn. In general, the lower the spring rate, the greater the cushioning effect, and the lower the roll resistance. Conversely, the higher the spring rate, the higher the roll resistance. While leaf spring suspensions provide adequate roll resistance, they do not provide the same degree of cushioning as an air spring, particularly when the trailer is empty or lightly loaded. The rough ride experienced with a leaf spring suspension at low trailer loads can contribute to cargo or trailer damage.

Specialized anti-roll components are added to an air spring suspension. However, these added components increase the weight and cost of the suspension. Torquing of the wheel axles is also utilized to develop roll resistance. However, axle torque can lead to axle failure. Thus, there is a need for a lightweight, inexpensive anti-roll device for an air spring suspension that will not significantly impact the ride-cushioning characteristics of such suspensions.

Prior art suspensions have incorporated two or more air springs that are fluidly connected in order to modify the suspension properties. U.S. Pat. No. 5,046,752 to Stephens et al. discloses a beam-type suspension assembly mounting two air springs straddling an axle connection at the center of a beam and fluidly connected for modification of the damping characteristics of the suspension assembly. A restriction in the fluid interconnection provides damping by restricting the air flow between the air springs.

U.S. Pat. No. 6,149,142 to Penzotti and U.S. Pat. No. 5,374,077 to Penzotti et al., and PCT application No. WO 00/06400 to Haire, published Feb. 10, 2000, disclose dual axle trailing arm type suspensions in which a first trailing arm suspending a first axle comprises an air spring which is fluidly interconnected with the air spring mounted to a second trailing arm suspending a second axle on the same side of the vehicle in order to modify the damping properties of the suspension system or provide improved traction to the vehicle's drive wheels.

In loading or unloading a trailer, the trailer is typically backed up against a dock and parked in this position. The bed of the trailer is usually level with the loading dock. On occasion, the front “landing gear” or “dolly legs” on the trailer are lowered until they contact the ground and the tractor is then removed. With the tractor disconnected from the trailer or otherwise not operational, the air spring pressure is not adjusted during loading and unloading.

As an empty trailer is loaded, the force from the weight of the goods being transferred to the trailer, and the loading equipment, such as a fork lift, lowers the rear portion of the trailer, a condition known as “squat.” “Squat” is the amount of vertical deflection in the suspension due to loading of the trailer, and is typically limited by stops in a trailing arm suspension to about 3 inches. If a slider assembly is used, and the slider is positioned at its forward limit, the lowering of the trailer floor adjacent to the dock can exceed twice this value. When the tractor is removed, the air spring pressure cannot be readily adjusted to compensate for squat.

While the rear portion of the trailer moves downwardly, the height of the front portion of the trailer is substantially fixed by the dolly legs or the tractor fifth wheel, and the trailer effectively rotates about the contact point of the dolly legs with the ground or the fifth wheel. In the case of a conventional trailing arm suspension, the downward movement of the rear of the trailer results in the rotation of the trailing arm about the pivotable connection between the trailing arm and the trailer frame. The angle of this rotation can be significant and results in the rotation of the wheels, which moves the trailer forward and away from the loading dock. This movement is referred to as “creep.” Trailer squat can create an undesirable vertical step between the loading dock and the floor of the trailer. Trailer creep can create an undesirable horizontal gap between the loading dock and the end of the trailer.

When the tractor remains attached to the trailer, the tractor can impede creep, particularly if the brakes have been set. As well, a tractor-mounted air compressor will typically be available to adjust the air spring height, thereby returning the trailer floor to an elevation level with the loading dock. Nevertheless, continued loading will induce additional squat until the air spring height is adjusted, and the additional squat will cause further creep.

Different devices have been developed to resist trailer creep. For example, a stop inserted between the trailer frame and the suspension can prevent the lowering of the trailer as loading progresses and thus prevent creep. However, such devices typically require operator input prior to or during the loading process. Additionally, mechanical devices can fail or be ignored. Additionally, such devices add weight to the trailer.

There is a significant need to reduce or eliminate trailer creep generated by loading and unloading. The anti-creep solution must be simple, reliable, and inexpensive if it is to be commercially viable. Further, the anti-creep solution must not interfere with the normal function of the suspension during normal operation thereof. Finally, the anti-creep solution should perform without the necessity of operator involvement during the loading and unloading processes.

### SUMMARY OF INVENTION

According to the invention, an improved trailer suspension for mounting ground-engaging wheels to a vehicle frame comprises a pair of beam assemblies adapted to be mounted to a different side of the vehicle frame and including a beam and two wheel-carrying axles mounted to each of the beams through an axle mounting assembly. Fluidly interconnected air springs are mounted to each of the beams and adapted to support the vehicle frame thereon. The fluid interconnection comprises an unrestricted flow conduit so that the spring rate of each of the air springs is relatively low during forward travel but relatively high during cornering. In one embodiment, the internal diameter of the flow conduit is at least ¾ inch. In another embodiment, the pressure in each of the air springs mounted to a single beam is equalized during compression of one of the air springs so that the spring rate of each of the air springs acting independently is the spring rate of an air spring having the volume of all the air springs mounted to the beam. In other words, the spring rate of each of the air springs mounted to the beam is the spring rate of each of the air springs individually when all the air springs are compressed as, for example, during roll. In a preferred embodiment, each of the air springs has a roll stiffness of at least 6,000 pounds per inch.

Each of the air springs can also contain an incompressible fluid, which is either water or a mixture of water and glycol. Each air spring can also comprise a solid insert.

Each air spring has a plate mounted to an upper and lower end of the air spring wherein the width of each plate is greater than a diameter of each air spring. The plates can comprise a plurality of concentric rings.

The beam also comprises at least one roll-restraint connector attached at one end to the beam and adapted to be attached at another end to the frame to limit the movement of the beam away from the frame. The roll-restraint connector is attached to the center of the beam by a flexible connector, which can be a chain. The suspension is also provided with two roll-restraint bumpers attached to the beam on either side of the roll-restraint connector. The bumpers are formed of an elastomeric material such as rubber. The roll-restraint bumpers can also be replaced with an air spring. The roll-restraint bumpers can also be attached to an end of the beam, and can be formed of an incompressible material.

A track bar is mounted at one end to one of the beams and at another end is adapted to be mounted to a frame. The track bar bracket forms at least one of the roll-restraint bumpers.

The beam can comprise an I-beam, or a hollow box beam. A radius rod pivotably connects one end of the beam to the vehicle frame and has a length that limits the creep of the trailer to a negligible amount. The axle mounting assembly comprises a two-pin resiliently-bushed connection.

In another embodiment of the invention, a trailer suspension for mounting ground-engaging wheels to a vehicle frame comprises a pair of beam assemblies adapted to be mounted to a different side of the vehicle frame and including a beam and two wheel-carrying axles mounted to each of the beams through an axle mounting assembly. At least one roll-restraint connector is attached at one end to the beam and adapted to be attached at another end to the frame to limit the movement of the beam away from the frame. At least one roll-restraint bumper is mounted to the beam and adapted to limit the contact of the beam with the frame when the vehicle undergoes roll.

The vehicle suspension according to the invention has a cushioned ride typical of a conventional air spring but has resistance to trailer roll and negligible trailer creep typical of a leaf spring suspension in a simple, lightweight assembly. Further, trailer creep is negligible.

Other objects, features, and advantages of the invention will be apparent from the ensuing description in conjunction with the accompanying drawings.

### BRIEF DESCRIPTION OF DRAWINGS

FIG. 1 is a schematic side view of a trailer adjacent a loading dock incorporating a first embodiment of a dual-axle suspension assembly according to the invention.

FIG. 2 is a perspective view from beneath the suspension assembly shown in FIG. 1 showing the suspension assembly suspended from a conventional trailer slider assembly.

FIG. 3 is a side elevational view of the suspension assembly shown in FIG. 2.

FIG. 3A is an exploded perspective view of the air spring of FIG. 3 showing concentric rings for selectively increasing the effective diameter of the mounting plates.

FIG. 4 is an oblique view of the front and side of the suspension assembly shown in FIG. 2.

FIG. 5 is an exploded view of a suspension beam comprising a part of the suspension assembly shown in FIG. 2.

FIG. 6 is a side elevational view of the outboard side of the suspension assembly shown in FIG. 2 illustrating the downward limit of travel of the trailer against the beam when the trailer is undergoing roll.

FIG. 7 is a side elevational view of the suspension assembly shown in FIG. 2 illustrating the upward limit of travel of a forward end of the beam when the leading axle is urged upwardly due to an attached wheel passing over a bump.

FIG. 8 is a side elevational view of the suspension assembly shown in FIG. 2 illustrating the downward limit of travel of a rearward end of the beam when the following axle is urged downwardly due to an attached wheel passing through a depression.

FIG. 9 is a side elevational view of the suspension assembly shown in FIG. 2 illustrating the downward limit of travel of the beam when the trailer is lifted into position on a railroad flatbed car.

FIG. 10 is a schematic representation of a load-deflection curve for a trailer undergoing roll supported on the suspension assembly shown in FIG. 2.

FIG. 11 is a perspective view from underneath of a second embodiment of a suspension assembly according to the invention.

FIG. 12 is a side elevational view of the suspension assembly shown in FIG.

FIG. 13 is a rear elevational view of the suspension assembly shown in FIG.

FIG. 14 is a side elevational view of a third embodiment of a suspension assembly according to the invention.

FIG. 15 is an exploded view of the suspension assembly illustrated in FIG.

FIG. 16 is a partial plan view of the underside of the suspension assembly illustrated in FIGS. 14 and 15.

### DETAILED DESCRIPTION

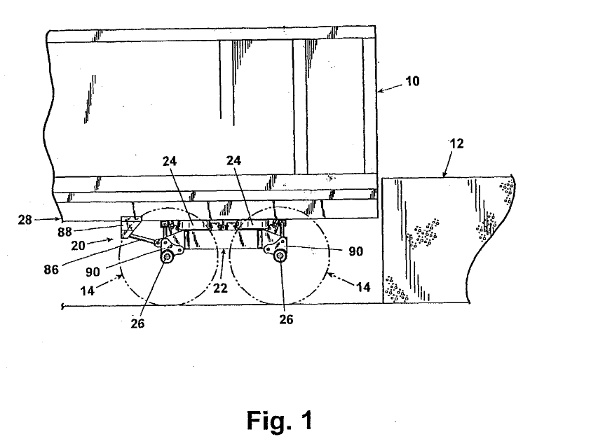

Referring now to FIG. 1, a conventional semi-trailer 10 is partially shown adjacent a loading dock 12. The front of the trailer 10 is to the left as viewed in FIG. 1. The trailer 10 is backed up to the loading dock 12 and parked so that the trailer just touches or almost touches the dock 12. The trailer 10 is supported by ground-contacting wheels 14 through the suspension assembly 20 described hereinafter, and by a fifth wheel when the tractor remains attached or dolly wheels if the tractor is removed. Each side of the trailer has an identical portion of the suspension assembly. As well, certain suspension elements are incorporated into the suspension assembly in pairs. Thus, like numerals will be used to identify like elements.

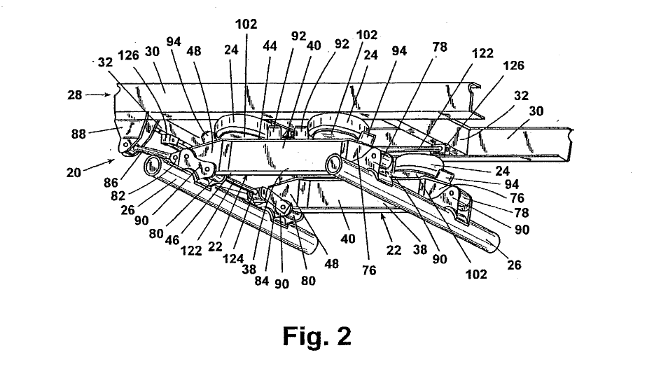

A first embodiment of the suspension assembly 20 is shown in FIGS. 2-4. In the preferred embodiment, the suspension assembly is suspended from a conventional slider assembly 28 comprising a pair of spaced-apart frame rails 30 with connecting cross-beams 32. The suspension assembly 20 comprises heavy fore-aft beams 22, air springs 24, and axles 26, and other conventional suspension elements such as axle adapters 90, shock absorbers 120, and track bars 122.

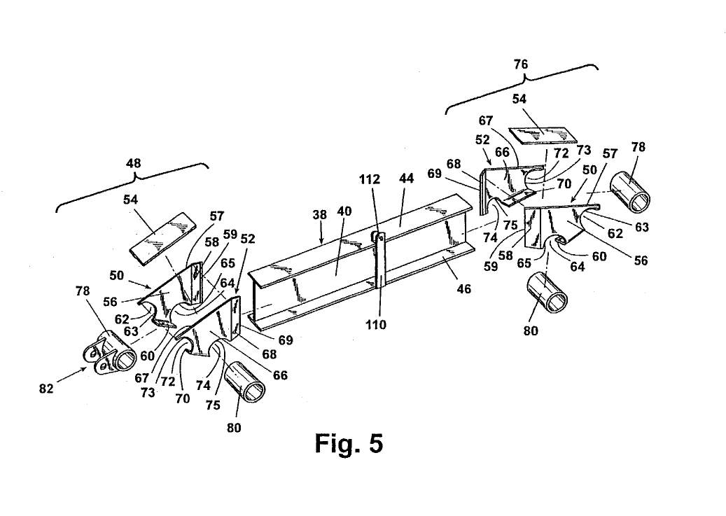

Referring now to FIG. 5, the beam 22 is a built-up elongated member comprising a generally conventional I-beam 38, a front end box assembly 48, and a rear end box assembly 76. The I-beam 38 comprises a plate-like web 40 rigidly connected along top and bottom edges to a top flange 44 and a bottom flange 46, respectively. A roll-restraint strap 110 comprises a generally rectangular-shaped, elongated, flat member, a first end of which terminates in a clevis 112. The roll-restraint strap 110 is adapted to be fixedly attached at a second end to the middle of the I-beam 38 at the interface of the web 40 and the lower flange 46, such as by welding. The strap 110 is adapted so that the clevis 112 extends beyond the upper flange 44 when the strap is attached to the I-beam 38. When the suspension assembly 20 is attached to the slider assembly 28, a roll-restraint chain 114 is connected from the roll-restraint strap 110 to the slider frame rail 30. In the preferred embodiment, a first end of the chain 114 is connected to the roll-restraint clevis 112 through a pinned or bolted connection, and a second end of the chain 114 is connected to the slider frame rail 30 in a conventional fashion such as with a bolted connection or a clevis mounted to the slider frame rail 30.

The front end box assembly 48 comprises a first end box side member 50, a second end box side member 52, and a top plate 54. The top plate 54 is a flat rectangular-shaped member with a width generally equal to the width of the top flange 44. The first end box side member 50 is a generally irregularly-shaped, plate-like member comprising a planar side wall 56, a planar beveled wall 58, a planar bottom flange 60, an upper bushing tube receptacle 62, and a lower bushing tube receptacle 64. A first end of the side wall 56 is connected to the beveled wall 58, which is inclined somewhat therefrom. A second end of the side wall 56 is connected to the bottom flange 60, which is orthogonal thereto. Opposite the bottom flange 60 the side wall 56 terminates in a side wall edge 57. The bottom flange terminates in a flange edge 61. The beveled wall terminates in a beveled wall edge 59. The upper bushing tube receptacle 62 defines an arcuate edge 63 in the side wall 56 extending from the side wall edge 57 to the bottom flange 60. The lower bushing tube receptacle 64 defines an arcuate edge 65 in the side wall 56 extending from the bottom flange 60 to the beveled wall 58.

The second end box side member 52 is a generally irregularly-shaped, plate-like member comprising a planar side wall 66, a planar beveled wall 68, a planar bottom flange 70, an upper bushing tube receptacle 72, and a lower bushing tube receptacle 74. A first end of the side wall 66 is connected to the beveled wall 68, which is inclined somewhat therefrom. A second end of the side wall 66 is connected to the bottom flange 70, which is orthogonal thereto. Opposite the bottom flange 70 the side wall 66 terminates in a side wall edge 67. The bottom flange terminates in a flange edge 71. The beveled wall terminates in a beveled wall edge 69. The upper bushing tube receptacle 72 defines an arcuate edge 73 in the side wall 66 extending from the side wall edge 67 to the bottom flange 70. The lower bushing tube receptacle 74 defines an arcuate edge 75 in the side wall 66 extending from the bottom flange 70 to the beveled wall 68. As shown in FIG. 5, the second end box side member 52 is a mirror image of the first end box side member 50.

The first end box side member 50 and the second end box side member 52 are assembled into the front end box assembly 48 by rigidly connecting the bottom flange 60 to the bottom flange 70 along the flange edges 61, 71, preferably by welding, to form a generally planar bottom wall. As so formed, the side walls 56, 66 are in a generally parallel relationship, with the distance between the side walls 56, 66 somewhat less than the width of the top plate 54 and the upper flange 44. The top plate 54 is rigidly attached to the first end box side member 50 and the second end box side member 52 along the side wall edges 57, 67, preferably by welding, to define a top wall extending from the beveled walls 58, 68 to the arcuate edges 63, 73. The top plate 54 overhangs the side walls 56, 66 somewhat to form flanges on either side of the front end box assembly 48. The beveled wall edges 59, 69 are separated a distance generally equal to the thickness of the web 40. This assemblage also forms the rear end box assembly 76.

An upper bushing tube 78 and a lower bushing tube 80 comprise generally heavy-walled tubes with an outside radius equal to the radius of curvature of the upper bushing tube receptacles 62, 72, and the lower bushing tube receptacles 64, 74, respectively. The upper and lower bushing tubes 78, 80 are adapted to be connected through conventional bushed connections to a conventional two-pin axle adapter 90. The upper and lower bushing tubes 78, 80 are rigidly connected to the box assemblies 48, 76, preferably by welding along the interface of the tube receptacles 62, 72 and the upper bushing tube 78, and the tube receptacles 64, 74 and the lower bushing tube 80. As assembled, the longitudinal axes of the bushing tubes 78, 80 are orthogonal to the side walls 56, 66. A conventional clevis 82 is rigidly connected such as by welding to one of the upper bushing tubes 78 for connection of a radius rod 86 as hereinafter described.

The box assemblies 48, 76 are rigidly attached to the ends of the I-beam 38 to form the beam 22. The front end box assembly 48 is connected to a first end of the I-beam 38 by inserting the web 40 into the space between the beveled wall edges 59, 69 so that the top plate 54 abuts the top flange 44 and the lower bushing tube 80 abuts the lower flange 46. The front end box assembly 48 is a rigidly attached to the I-beam 38, preferably by welding along the interfaces between the top plate 54 and the top flange 44, the lower bushing tube 80 and the bottom flange 46, and the beveled wall edges 59, 69 and the web 40. The rear end box assembly 76 is rigidly connected to a second end of the I-beam 38 in a similar fashion.

The suspension assembly has been herein described as comprising a modified I-beam, which is generally easier to fabricate and has a preferred strength-to-weight ratio in a vertical direction. With the appropriate adaptations evident to one of ordinary skill in the art, the suspension assembly can comprise other fore-aft beams of suitable load-carrying capacity and configuration, such as a hollow box beam.

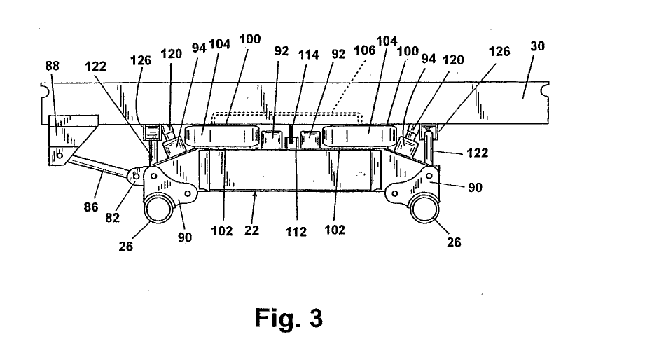

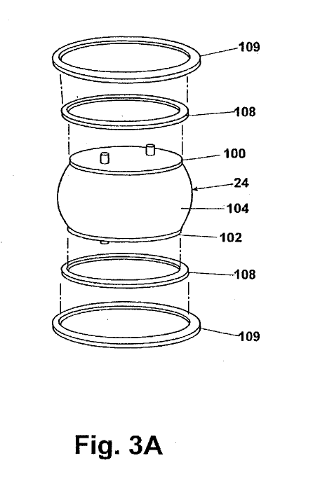

Referring again to FIGS. 2-4, two low-volume, low-clearance air springs 24 are attached to the top flange 44 of the I-beam 38 in spaced-apart relationship using conventional fasteners, such as bolted connections or welding (not shown) between the bottom mounting plate 102 and the flange 44. A conventional air spring has a roll stiffness of about 3000 lb/in. A mechanical spring has a roll stiffness of about 7000 lb/in. The roll stiffness for each of the low-volume air springs is preferably in the range of 6-7000 lb/in, thus approaching the stiffness of a mechanical spring. Each air spring 24 comprises a low-profile air bag 104, a top mounting plate 100, and a bottom mounting plate 102. The air springs 24 are mounted at approximately the quarter points of the I-beam 38. The air springs 24 are also mounted to the slider frame rails 30 by conventional bolted or welded connections (not shown) between the top mounting plate 100 and the slider frame rail 30. The fore-and-aft air bags 104 are in fluid communication through a large diameter conduit 106 connecting the interior of each air bag 104 with an air-tight connection through the top mounting plates 100. In the preferred embodiment, the diameter of the conduit 106 is at least ¾-inch. As shown in FIG. 3A, the diameter of the top mounting plate 100 and the bottom mounting plate 102 can be increased through the use of concentric rings 108, 109, or through the use of mounting plates with a selectively increased diameter. A first ring 108 is slidably received around each of the plates 100, 102 to effectively increase the diameter of the plate 100, 102. A second ring 109 is slidably received around each ring 108 to further increase the effective diameter of the mounting plates. Subsequent rings of increasing diameter can be added to provide a mounting plate of a selected diameter. The increase in diameter of the mounting plates 100, 102 increases the spring rate or stiffness of the air spring 24. Alternatively, the stiffness of the air spring 24 can be increased to approach the stiffness of a mechanical spring through the use of a water-glycol mixture, or a solid insert such as a pedestal, to partially fill the interior of the air bag 104.

A pair of conventional height control valves (not shown) are used to maintain the air springs 24 at a selected height. One height control valve is used for each pair of interconnected fore-and-aft air springs 24. The use of a height control valve for each pair of interconnected air springs provides control of the trailer height in response to unequal loading.

Two center roll-restraint bumpers 92 are attached to the top of each beam 22 at a central portion thereof, preferably on either side of the roll-restraint strap 110. Two end roll-restraint bumpers 94 are located generally at the ends he beam 22. The bumpers 92, 94 are preferably formed of an elastomeric material such as rubber. The bumpers have a relative high durometer but have some resilience for some cushioning during roll.

A conventional radius rod bracket 88 is rigidly attached to the slider frame rail 30 such as by welding or bolted connections. A first end of a conventional radius rod 86 is connected to the radius rod bracket 88 and a second end of the radius rod is connected to the radius rod clevis 82 through conventional resilient bushed connections.

A pair of conventional bushed two-pin axle brackets 90 are connected to each axle 26 in a conventional fashion, such as by welding. Resilient bushings (not shown) are contained within the upper bushing tubes 78 and lower bushing tubes 80. The axle brackets 90 are then attached to the beam 22 by pinned connections extending through the bushings and the upper and lower bushing tubes 78, 80. The axle brackets 90 and the upper and lower bushing tubes 78, 80 are adapted so that the axles 26 are positioned at or slightly outwardly of the ends of the beam 22, as shown in FIG. 3. Positioning the axles 26 at or slightly outwardly of the ends of the beam 22 enhances the load cushioning provided by the suspension assembly 20. As well, because of the connection of the axles 26 through the beam 22, load and deflection reactions are shared essentially-equally by both axles 26.

As shown in FIG. 2, a track rod bracket plate 84 is a flat, irregularly-shaped, elongated member adapted to be connected to an axle bracket 90 through the connecting pins used to connect the axle bracket 90 to the beam 22. A lower track rod clevis 124 is fixedly connected, such as by welding, to the track rod bracket plate 84 for connection with a first end of a conventional track rod 122. An upper track rod clevis 126 is fixedly connected to the slider frame 28, such as to a crossbeam 32, for connection with a second end of a conventional track rod 122. In the preferred embodiment, the track rod 122 is pivotally connected through resilient bushed connections to the upper track rod clevis 126 and the lower track rod clevis 124.

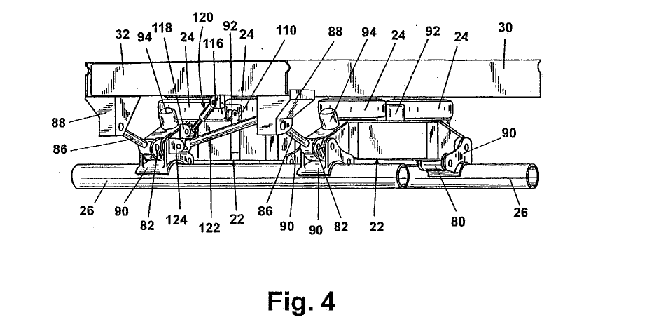

Referring specifically to FIGS. 3-4, conventional shock absorbers 120 are pivotably connected to each end of the beam 22 through a lower shock absorber clevis 118 and to the slider frame 28 through an upper shock absorber clevis 116. Each shock absorber clevis 116, 118 is fixedly connected in a conventional fashion such as by welding to the slider frame 28 and the beam 22, respectively. The shock absorbers can also limit the amount of separation between the beams 22 and the slider frame 28.

The suspension can be used with wheels incorporating both conventional drum brakes and disc brakes (not shown). With drum brakes, utilizing conventional spring brake actuators (not shown), the actuators will typically be attached to the axles so that the actuator rods are parallel to the wheel and perpendicular to the axle. With disc brakes, the actuators are oriented so that the actuator rods are parallel to the axle. All other elements of the suspension assembly described herein will generally remain the same regardless of whether drum brakes or disc brakes are utilized.

The interconnection of the two air springs 24 fore and aft on the trailer 10 equalizes the air pressure between the air springs 24. When, for example, the forward wheel 14 is deflected upward by a bump in the road, the forward air spring 24 will be compressed. The air pressure will be equalized between the fore-and-aft air springs 24, which will effectively double the volume of each air spring 24, thereby decreasing its spring rate to approximately 3000 lb/in and providing the ride-cushioning property of a conventional air spring. Although each air spring 24 may have a relatively high spring rate, the combined air springs 24 have a relatively low spring rate and the ride of the trailer will be cushioned. However, in a roll situation in which each air spring 24 on the outboard side of the trailer 10 experiences essentially the same compression, the volume of each air spring 24 is effectively unchanged, as is the spring rate. The higher spring rate, i.e. 6-7000 lb/in, limits the trailer roll.

In addition to the roll resistance provided by the air springs 24, roll is also limited by the center roll-restraint bumpers 92 on the outboard side of the trailer 10. As the trailer 10 is driven around a corner, centrifugal force urges the trailer 10 into a roll to the outboard side, i.e. away from the direction of the turn. This roll tends to force the outboard side of the trailer 10 downward so that the slider frame rail 30 is forced toward the beam 22. At the same time, the inboard side of the trailer 10 is forced upward, due to both centrifugal force and the upward force exerted by the air springs 24 on the inboard side. Roll is limited by the center roll-restraint bumpers 92 making contact with the center roll-restraint bumpers 92 as the air springs 24 are compressed. Additionally, roll is limited by tensioning of the roll-restraint chain 114 on the inboard side of the trailer 10. Significantly, axle torque is not relied upon for roll resistance.

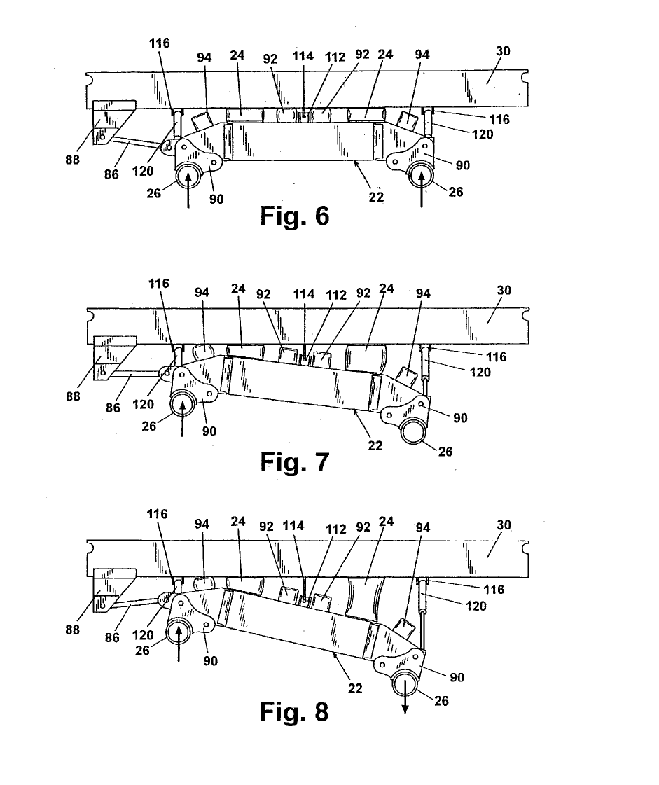

FIGS. 6-9 illustrate the action of the suspension assembly 20 under different loading conditions. FIG. 6 illustrates the outboard side of the suspension under conditions of trailer roll. As the trailer 10 negotiates a corner, centrifugal force urges the trailer 10 into a roll to the outboard side. This roll tends to force the outboard side of the trailer 10 downward so that the slider frame rail 30 is forced toward the beam 22. At the same time, the inboard side of the trailer 10 is forced upward, due to both centrifugal force and the upward force exerted by the air springs 24 on the inboard side. The trailer roll will cause the slider frame rail 30 to contact the center roll-restraint bumpers 92. Some compression of the shock absorbers 120 and the air springs 24 will also occur.

FIG. 7 illustrates the upward deflection of the forward end of the beam 22 when the leading wheel 14 passes over a bump in the road. The upward deflection of the forward end of the beam 22 is limited by the contact of the end roll-restraint bumper 94 with the slider frame rail 30. Compression of the forward shock absorber 120 and the forward air spring (not shown) will occur. Extension of the rear shock absorber 120 and the rear air spring (not shown) will also occur.

FIG. 8 illustrates the downward deflection of the rear of the beam 22, such as when the leading wheel 14 passes over a bump in the road at the same time that the trailing wheel 14 passes through a depression. The resulting downward deflection of the rear of the beam 22 is limited by the maximum extension of the rear shock absorber 120.

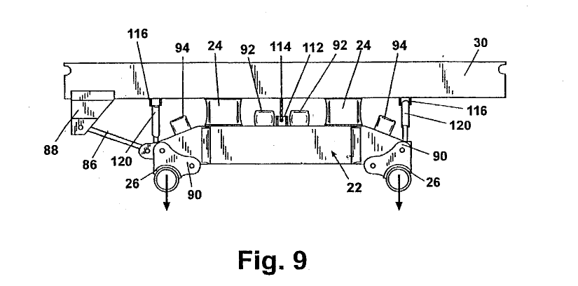

FIG. 9 illustrates the suspension of the suspension assembly 20 by the roll-restraint chains 114 when the trailer is lifted for placement on a railroad flatcar. When the trailer is lifted, the roll-restraint chains 114 suspend the suspension assembly 20 from the slider frame 28, thereby preventing the air springs 24 from being overextended, losing air pressure, and possibly becoming damaged. Should loss of air spring pressure occurring the travel on the flat car, the slider frame 28 will be supported on the center roll-restraint bumpers 92.

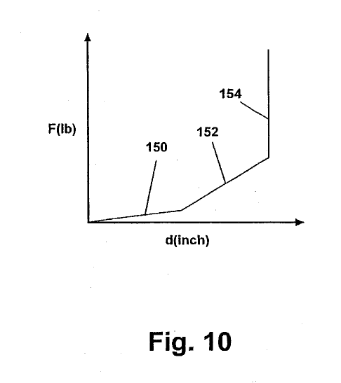

The roll resistance of the suspension assembly is generally represented by the load-deflection curve shown in FIG. 10. This load-deflection curve illustrates that the suspension assembly described herein has a variable roll stiffness resulting from three different roll-control mechanisms. An initial roll stiffness is represented by the curve segment 150, which is provided only by the air springs 24. The air springs 24 on the outboard side of the trailer 10 will resist roll while the air springs 24 on the inboard side will contribute to roll. If the roll reaches a certain magnitude, the chain 14 on the inboard side of the trailer 10 will reach its limit of extension, and the upward movement of the frame 28 with respect to the wheels 14 will be limited to prevent further roll. The roll stiffness representing this mechanism is represented by the curve segment 152, which will be defined by the combination of the action of the chain 114 on the inboard side of the trailer 10 and the air springs 24 on the outboard side of the trailer 10. As roll continues, the slider frame rails 30 on the outboard side of trailer 10 will contact the center roll-restraint bumpers 92, as illustrated in FIG. 6, resulting in a high stiffness value represented by the curve segment 154, which is defined by the combination of the action of the chain 114 on the inboard side and the bumpers 92 on the outboard side.

During loading of the trailer 10, the trailer body will be lowered toward the suspension assembly 20, causing the trailer 10 to rotate about the dolly legs or the fifth wheel. The beam 22 will generally not rotate in response to trailer loading as does a conventional trailing arm. If the beam 22 does pivot, the magnitude of the resulting angle of rotation of the beam 22 is minimized by the angular deflection of the radius rod 86, thus minimizing the resulting creep. In the herein-described embodiment, the radius rod 86 is relatively long so that vertical movement of the radius rod-to-beam connection is limited. For a radius rod length of approximately 19 inches, the maximum deflection of the radius rod-to-beam connection resulting from a full trailer load is approximately 1/32-inch. The resulting creep is limited thereby to about 1/32-inch, which is well within acceptable limits. Furthermore, the center roll-restraint bumpers 92 will limit squat during loading to 1¼ inches (i.e. the clearance between the center roll-restraint bumpers 92 and the bottom of the slider frame rail 30), as compared to the 3 inches typically experienced with a trailing arm suspension.

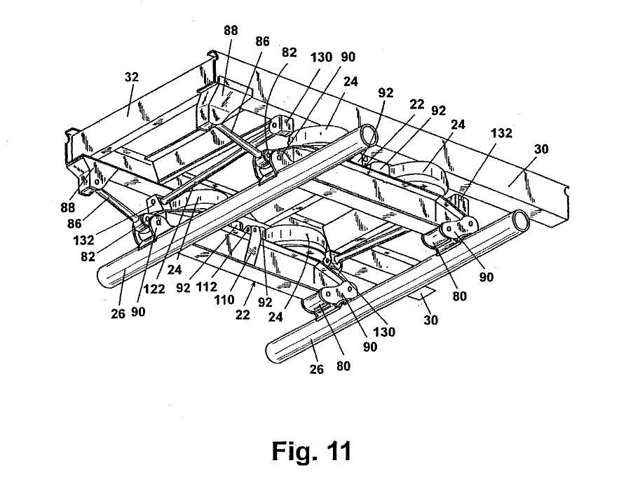

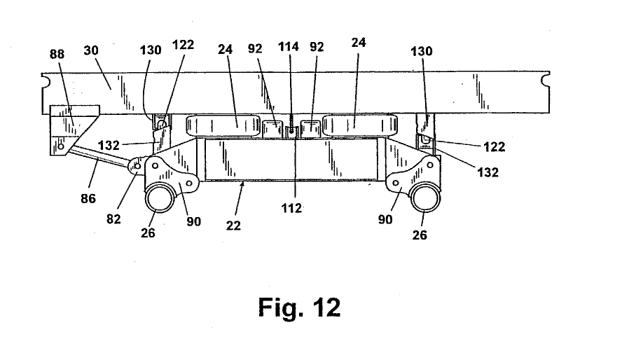

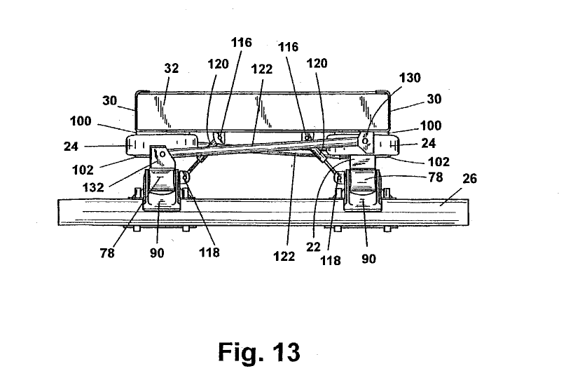

A second embodiment of the suspension system is shown in FIGS. 11-13. The second embodiment is generally the same as the first embodiment, except that the end roll-restraint bumpers are replaced by axle stops that connect conventional track rods into the suspension assembly. A lower axle stop 132 is fixedly attached, such as by welding, to the top plate 54 adjacent the end of the beam 22. An upper axle stop 130 is fixedly attached, such as by welding, to the underside of the slider frame rail 30. Each axle stop 130, 132 comprises a clevis adapted for connection of a conventional track rod 122. The lower axle stop 132 is located on one top plate 54 to limit movement of one of the beams 22 toward the above-located slider frame rail 30 by the lower axle stop 132 contacting the underside of the slider frame rail 30. Similarly, the upper axle stop 130 is located on the underside of the opposite slider frame rail 30 to limit movement of the opposite beam 22 toward the slider frame rail 30 by the upper axle stop 130 contacting the top plate 54 of the opposite beam 22. All other elements of the suspension assembly as described with respect to the first embodiment are preferably present in the second embodiment, and the roll resistance, beam movement, and creep limitations of the second embodiment are generally the same as for the first embodiment.

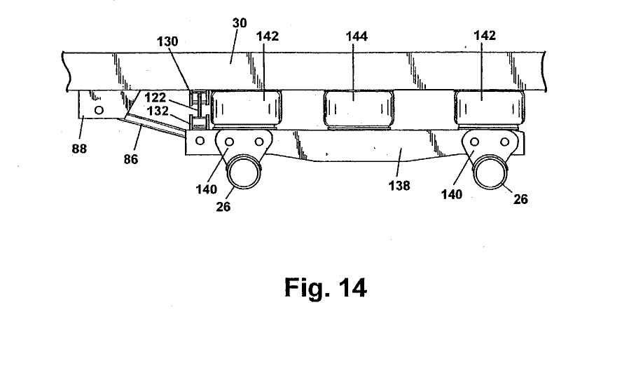

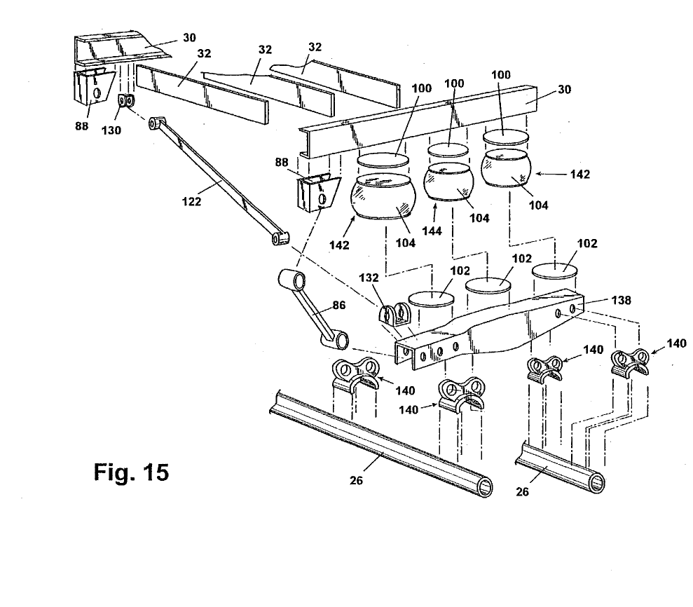

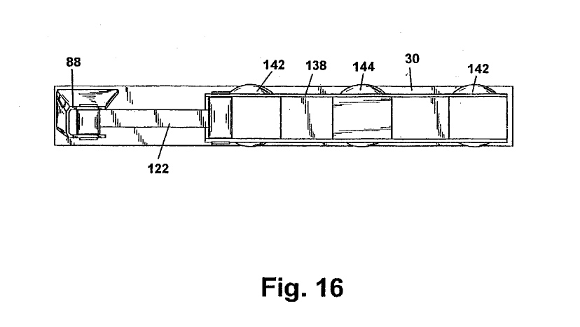

Referring now to FIGS. 14-16, a third embodiment of the suspension assembly comprises a pair of conventional box beams 138 and triple air springs 142, 144. The third embodiment is generally the same as the first embodiment, except that the center roll-restraint bumpers 92 are replaced by a third, centrally positioned air spring 144 having a spring rate somewhat greater than that of the other two air springs 142. As shown, each beam 138 comprises a hollow assembly of walls with a generally square cross section. Each beam 138 also comprises a radius rod receptacle 146 at a leading end for connecting the beam 138 to a radius rod 86. The receptacle 146 can be formed into the beam 138 as shown, or can comprise a clevis or other suitable connecting assembly.

Three air spring lower mounting plates 102 are attached to the top of the beam 138, two near each end thereof and the third intermediate the ends of the beam 138. The plates 102 are attached to the beam 138, preferably by welding. Air springs 142, 144 are mounted to the lower mounting plates 102 utilizing conventional fasteners (not shown). Upper air spring mounting plates 100 are attached to the slider frame rail 30 to receive the air springs 142, 144 using conventional fasteners (not shown). The middle air spring 144 can be partially filled with a water-glycol mixture to increase the roll resistance of the spring. As with the first embodiment, the fore-aft air springs 142 can be plumbed together with a large-diameter air line (not shown).

A conventional radius rod 86 is connected to a hanger bracket 88 through a resilient bushed connection (not shown) and to the radius rod receptacle 146 utilizing a resilient bushed connection (not shown).

A conventional two-pin axle adapter 140 utilizing resilient bushed connections connects the axles 26 to the beam 138. A lower clevis 132 is attached to the top of the beam 138 at the forward end, preferably by welding. An upper clevis 130 is attached to the side rail 30 at the opposite side of the trailer 10. A conventional track rod 122 is connected laterally across the trailer 10 to the lower clevis 132 and to the upper clevis 130 using conventional resilient bushed connections (not shown). Shock absorbers (not shown) can also be mounted in a conventional fashion between the beam 138 and the slider assembly 28.

In the third embodiment, the beam 138 is able to pivot about the relatively stiffer center air spring 144. As the trailer 10 is loaded, the air springs 142, 144 are compressed and the trailer 10 is lowered relative to the suspension assembly 20. Since the beam 138 does not rotate in response to the loading as does a conventional trailing arm, the wheels 14 do not rotate. However, if loading does pivot the beam 138 about the center air spring, the magnitude of the resulting rotation of the beam 138 is minimized by the radius rod 86, thus minimizing the resulting creep.

When the trailer 10 negotiates a curve, roll will result in the raising of the inboard side of the trailer 10, and the lowering of the outboard side. The distance by which the outboard side is lowered is limited by the stiffness of the center air spring 144. As well, a roll-restraint chain (not shown) can be used as with the first two embodiments to limit the upward movement of the inboard side of the trailer 10. Thus, the third embodiment suspension assembly has a relatively high roll resistance, a relatively low spring rate, and negligible creep.

While the invention has been specifically described in connection with certain specific embodiments thereof, it is to be understood that this is by way of illustration and not of limitation, and the scope of the appended claims should be construed as broadly as the prior art will permit.

1. In a trailer suspension for mounting ground-engaging wheels to a vehicle frame, the suspension comprising a pair of beam assemblies, each beam assembly is adapted to be mounted to a different side of the vehicle frame and comprising a beam and two wheel-carrying axles mounted to each of the beams through an axle mounting assembly, the improvement comprising:
at least two fluidly interconnected air springs mounted to each of the beams and adapted to support the vehicle frame thereon.

2. The trailer suspension according to claim 1 wherein the fluid interconnection comprises an unrestricted flow conduit so that the spring rate of each of the at least two air springs is relatively low during forward travel but relatively high during cornering.

3. The trailer suspension according to claim 2 wherein the internal diameter of the flow conduit is at least ¾ inch.

4. The trailer suspension according to claim 1 wherein the fluid interconnection comprises an unrestricted flow conduit so that the pressure in each of the at least two air springs is equalized during compression of one of the at least two air springs so that the spring rate of each of the at least two air springs acting independently is the spring rate of an air spring having the volume of the at least two air springs.

5. The trailer suspension according to claim 4 wherein the spring rate of each of the at least two air springs is the spring rate of each of the at least two air springs individually when both of the at least two air springs are compressed as, for example, during roll.

6. The trailer suspension according to claim 5 wherein the internal diameter of the flow conduit is at least ¾ inch.

7. The trailer suspension according to claim 1 wherein each of the at least two air springs has a roll stiffness of at least 6,000 pounds per inch.

8. The trailer suspension according to claim 1 wherein each of the at least two air springs contains an incompressible fluid.

9. The trailer suspension according to claim 8 wherein the incompressible fluid is water.

10. The trailer suspension according to claim 8 wherein the incompressible fluid is a mixture of water and glycol.

11. The trailer suspension according to claim 1 wherein each of the at least two air springs further comprises a solid insert.

12. The trailer suspension according to claim 1 wherein each of the at least two air springs has a plate mounted to an upper and lower end thereof and the diameter of each of the plates is greater than a diameter of each of the at least two air springs.

13. The trailer suspension according to claim 12 wherein the plates comprise a plurality of concentric rings.

14. The trailer suspension according to claim 1 wherein the beam further comprises at least one roll-restraint connector attached at one end to the beam and adapted to be attached at another end to the frame to limit the movement of the beam away from the frame.

15. The trailer suspension according to claim 14 wherein the at least one roll-restraint connector is attached to the center of the beam.

16. The trailer suspension according to claim 15 wherein the at least one roll-restraint connector includes a flexible connector.

17. The trailer suspension according to claim 16 wherein the flexible connector is a chain.

18. The trailer suspension according to claim 14 and further comprising at least one roll-restraint bumper.

19. The trailer suspension according to claim 18 wherein the at least one roll-restraint bumper comprises two roll-restraint bumpers.

20. The trailer suspension according to claim 19 wherein the roll-restraint bumpers are attached to the beam on either side of the at least one roll-restraint connector.

21. The trailer suspension according to claim 20 wherein the roll-restraint bumpers are formed of an elastomeric material.

22. The trailer suspension according to claim 21 wherein the elastomeric material is rubber.

23. The trailer suspension according to claim 18 wherein the at least one roll-restraint bumper comprises an air spring.

24. The trailer suspension according to claim 18 wherein the at least one roll-restraint bumper is attached to the beam at an end of the beam.

25. The trailer suspension according to claim 24 wherein the at least one roll-restraint bumper is formed of an incompressible material.

26. The trailer suspension according to claim 25 and further comprising a track bar mounted at one end to one of the beams and at another end adapted to be mounted to a frame, and wherein the track bar bracket forms at least one of the roll-restraint bumpers.

27. The trailer suspension according to claim 1 wherein the beam comprises an I-beam.

28. The trailer suspension according to claim 1 wherein the beam comprises a hollow box beam.

29. The trailer suspension according to claim 1 and further comprising a radius rod pivotably connecting one end of the beam to the vehicle frame.

30. The trailer suspension according to claim 29 wherein the radius rod has a length that limits the creep of the trailer to a negligible amount.

31. The trailer suspension according to claim 1 wherein the axle mounting assembly comprises a two-pin resiliently-bushed connection.

32. In a trailer suspension for mounting ground-engaging wheels to a vehicle frame, the suspension comprising a pair of beam assemblies, each beam assembly is adapted to be mounted to a different side of the vehicle frame and comprising a beam and two wheel-carrying axles mounted to each of the beams through an axle mounting assembly, the improvement comprising:
at least one roll-restraint connector attached at one end to the beam and adapted to be attached at another end to the frame to limit the movement of the beam away from the frame, and
at least one roll-restraint bumper mounted to the beam and adapted to limit the contact of the beam with the frame when the vehicle undergoes roll.

33. The trailer suspension according to claim 32 wherein the at least one roll-restraint connector is attached to the center of the beam.

34. The trailer suspension according to claim 32 wherein the at least one roll-restraint connector includes a flexible connector.

35. The trailer suspension according to claim 34 wherein the flexible connector is a chain.

36. The trailer suspension according to claim 35 and further comprising at least one roll-restraint bumper.

37. The trailer suspension according to claim 36 wherein the at least one roll-restraint bumper comprises two roll-restraint bumpers.

38. The trailer suspension according to claim 37 wherein the roll-restraint bumpers are attached to the beam on either side of the at least one roll-restraint connector.

39. The trailer suspension according to claim 38 wherein the roll-restraint bumpers are formed of an elastomeric material.

40. The trailer suspension according to claim 39 wherein the elastomeric material is rubber.

41. The trailer suspension according to claim 36 wherein the at least one roll-restraint bumper comprises an air spring.

42. The trailer suspension according to claim 36 wherein the at least one roll-restraint bumper is attached to the beam at an end of the beam.

43. The trailer suspension according to claim 42 wherein the at least one roll-restraint bumper is formed of an incompressible material.

44. The trailer suspension according to claim 43 and further comprising a track bar mounted at one end to one of the beams and at another end adapted to be mounted to a frame, and wherein the track bar bracket forms at least one of the roll-restraint bumpers.

45. The trailer suspension according to claim 32 wherein the beam comprises an I-beam.

46. The trailer suspension according to claim 32 wherein the beam comprises a hollow box beam.

47. The trailer suspension according to claim 32 and further comprising a radius rod pivotably connecting one end of the beam to the vehicle frame.

48. The trailer suspension according to claim 47 wherein the radius rod has a length that limits the creep of the trailer to a negligible amount.

49. The trailer suspension according to claim 32 wherein the axle mounting assembly comprises a two-pin resiliently-bushed connection.
